(19) United States
(12) Patent Application Publication
(10) Pub. No.: US 2003/0234031 A1
(43) Pub. Date: Dec. 25, 2003

(54) Automotive washer system with temperature adaptive washer fluid heating and mixing

(75) Inventors: Edward K. Krause, Ann Arbor, MI (US); Michael L. Greenfield, Providence, RI (US); Scott Alan Wojan, Novi, MI (US); Timothy John Wallington, Ann Arbor, MI (US)

Correspondence Address: DYKEMA GOSSETT PLLC, 315 EAST EISENHOWER PARKWAY, SUITE 100, ANN ARBOR, MI, 48108-3306, US

(73) Assignee: Ford Global Technologies, Inc., Dearborn, MI (US)

(21) Appl. No.: 10/064,234

(22) Filed: Jun. 24, 2002

(51) Int. Cl. B60S 3/04

(52) U.S. Cl. 134/18; 134/36

(57) ABSTRACT

An automotive washer system for exterior surfaces such as a windshield includes first and second reservoirs with freezable and freeze-resistant fluids, a mixer for combining fluids from the first and second reservoirs, and a controller for determining a relative proportion for combining the fluids from the first and second reservoirs and for operating the mixing valve to achieve the determined relative proportion between the fluids. In this manner, freezing of the washer system is avoided while using a minimum amount of freeze-resistant fluid.

### BACKGROUND OF INVENTION

1. Field of the Invention

The present invention relates to a system for providing fluid to the exterior surface of a vehicle, such as a windshield, for the purpose of cleaning same.

2. Disclosure Information

Washer systems have been used in automotive vehicles for many years. As is well known, such systems typically apply a fluid which aids the action of the wiper blades in cleaning the windshield or other exterior surface, such as a lamp lens. Because many vehicles are required to operate in ambient temperatures below freezing, it has been necessary to provide an additive to the fluid so as to depress its freezing point. Typically, an alcohol such as methanol is used to depress the freezing point of washer fluid, making the washer suitably fluid freeze resistant. However, as vehicle emissions regulations become increasingly more stringent, it has become increasingly more desirable to limit the emissions of all forms of volatile organic compounds (VOC) from the vehicle. Accordingly, it is desirable to limit the use of alcohol. Of course, at ambient temperatures below freezing, it is difficult to use neat water. The present invention solves the problems associated with using neat water and allows the cleaning of vehicular surfaces with neat water or perhaps with water having a small amount of soap therein, but in either case without the use of methanol or other suitable VOC at higher ambients, while providing a freeze protected system and washer fluid at sub-freezing ambients.

### SUMMARY OF INVENTION

A temperature adaptive washer system for an automotive vehicle includes a first reservoir containing freezable fluid, a second reservoir containing a freeze-resistant fluid, a mixer for combining fluids from the first and second reservoirs, and a controller operatively connected with the mixer, for determining a relative proportion for combining the fluids from the first and second reservoirs.

The present washer system further comprises a temperature sensor operatively connected with the controller. The controller determines the relative proportion for combining fluids from the first and second reservoirs based at least in part upon an output from the temperature sensor. In order to accomplish this proportioning, the controller comprises a memory for storing values corresponding to previously chosen relative proportions as well as to the temperature output of the sensor.

The present system further comprises a heater for increasing the temperature of washer fluid within the mixer. The heater is operated by the controller such that the heater is energized according to the stored values of temperature and fluid proportion. In effect, the controller's memory stores a temperature value corresponding to the temperature of at least a portion of a fluid distribution system operatively associated with the mixer each time fluid passes through the fluid distribution system. The controller operates the heater as a function of at least the previously stored value of the temperature.

It is an advantage of the present invention that the use of freeze-resistant washer fluid and associated freezing point depressants may be minimized because the present system allows heating of the mixer and fluid distribution system so as to mitigate plugging of the system with ice at low ambient temperatures.

It is a further advantage that the use of all forms of VOC as washer antifreeze may be mitigated through the use of the present system.

Other advantages, as well as objects and features of the present invention will become apparent to the reader of this specification.

### BRIEF DESCRIPTION OF DRAWINGS

FIG. 1 is a schematic representation of an automotive washer system according to the present invention.

FIG. 2 is a flow chart illustrating operation of a system according to the present invention.

### DETAILED DESCRIPTION

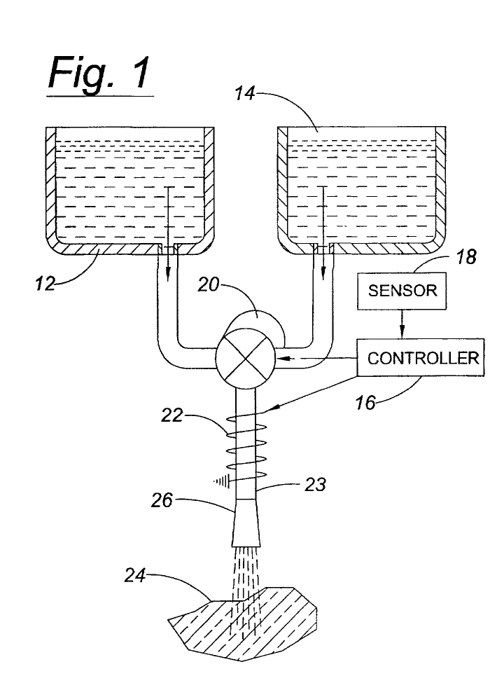

As shown in FIG. 1, an automotive washer system includes first reservoir 12 which contains an aqueous-based, freezable fluid. The second reservoir 14 has a suitably freeze-resistant fluid contained therein. Mixer 20 combines fluids from the first and second reservoirs. Controller 16, which receives information from temperature sensor 18, is operatively connected with mixer 20. Controller 16 determines the relative proportion for combining the fluids from reservoirs 12 and 14 so as to provide a fluid suitably freeze-resistant according to the ambient temperature in which an automotive vehicle having the present system is being used. Those skilled in the art will appreciate in view of this disclosure that a variety of methods are available for controller 16 to select an appropriate mixing proportion or ratio, Vm, for the fluids drawn from reservoirs 12 and 14. For example, controller 16 could use either a lookup table, or an equation-based calculation, with both having sensed temperature as an input, to determine the relative proportions of liquid (Vm) from the two reservoirs.

Previously mentioned temperature sensor 18 plays a key role in allowing temperature controller 16 to mix appropriate fluid using mixer 20. It should be noted in this regard that mixer 20 comprises any of a suitable number of multi port mixing valves, as well as a pump drawn from any of the varieties of mixing valves and pumps known to those skilled in the art and suggested by this disclosure. An important point herein is that controller 16, using information on the ambient temperature or some other system temperature, controls the mixing ratio of fluids from reservoirs 12 and 14 so as to provide a fluid which will not freeze subsequently in nozzle 26 or any of the plumbing upstream thereof.

Controller 16 includes a memory for storing values corresponding to calculated relative proportions and to the temperature output of sensor 18. In this fashion, when the driver of the vehicle calls for washer action, controller 16 will know, based on the contemporary or instantaneous signal from sensor 18, whether the mixture which was previously ejected through nozzle 26 is likely to have frozen within nozzle 26 and its upstream plumbing extending between nozzle 26 and mixer 20. If the previously determined value of the mix provides inadequate freezing protection, controller 16 will energize heater 22 so as to apply heat to the system, including nozzle 26 and line 23 extending between nozzle 26 and mixing valve 20. In this fashion, controller 16 will melt any ice extending either in mixer 20, nozzle 26, or line 23.

Regardless of the operation of the present system, it is intended to apply fluid to an outer surface of a vehicle, such as the windshield which is shown schematically at 24 in FIG. 1. Those skilled in the art will appreciate in view of this disclosure that a system according to the present invention can be used to apply washer fluid not only to a windshield, but also to various lamp lenses and other surfaces of a vehicle.

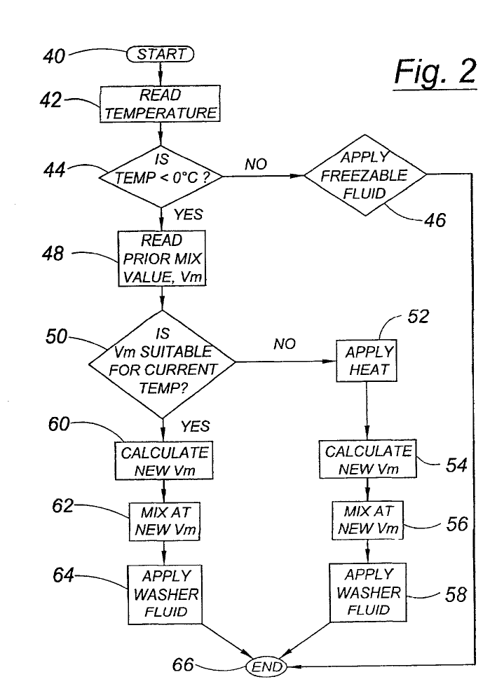

FIG. 2 illustrates operation of a system according to the present invention. When the customer or the driver of a vehicle calls for washer operation, the routine starts at block 40. Moving to block 42, temperature is read by controller 16 via sensor 18. At block 44, the question is asked whether the ambient temperature is less than zero degrees centigrade. If the temperature is greater than zero degrees centigrade, the routine moves to block 46 wherein a freezable fluid, such as neat water, will be applied by the present system to the window or other exterior surface of the vehicle. This means that fluid will be used exclusively from reservoir 12. Thereafter, the routine ends at block 66. Those skilled in the art will appreciate in view of this disclosure that the precise temperature setpoint for determining when the mixing of freeze-resistant fluid with neat water should occur is a design detail entrusted to those desiring to implement a system according to the present invention

If the answer to the question posed in block 44 is “yes”, this of course means that the temperature is less than zero degrees centigrade, and the routine moves to block 48, wherein the prior mix value (Vm) is read. Vm represents the relative proportion of the freezable fluid or aqueous fluid from reservoir 12, as compared to the freeze-resistant fluid from reservoir 14. Continuing with the method of FIG. 2 at block 50, the question is asked whether an immediately prior mix value (Vm) is suitable for the current sensed temperature. If the answer is “yes”, a new value of Vm is nevertheless calculated and stored at block 60 and fluid is mixed at the new Vm value at block 62 and applied to the vehicular surface to be cleaned at block 64. Thereafter, the routine ends at block 66.

If the answer to the question of the suitability of the previous Vm for the current temperature at block 50 is “no” at block 50, the routine moves to block 52 wherein heat is applied by controller 16 via heating element 22 and then the routine moves to block 54 where a new value of Vm is calculated and stored by controller 16. Thereafter at block 56, washer fluid is mixed at the new value of Vm and applied to the vehicular surface to be cleaned at block 58.

While the best mode for carrying out the invention has been described in detail, those familiar with the art to which this invention relates will recognize various alternative designs and embodiments for practicing the invention as defined by the following claims. For example, the threshold value of block 44 of FIG. 2 may be set at any suitable temperature either above or below freezing.

1. An washer system for an automotive vehicle, comprising:
a first reservoir containing a freezable fluid;
a second reservoir containing freeze-resistant fluid;
a mixer for combining fluids from the first and second reservoirs; and
a controller, operatively connected with the mixer, for determining a relative proportion for combining the fluids from said first and second reservoirs.

2. An automotive washer system according to claim 1, further comprising a temperature sensor operatively connected with said controller, with said controller determining said relative proportion based at least in part upon an output from said sensor.

3. An automotive washer system according to claim 2, wherein said controller further comprises a memory for storing values corresponding to said relative proportion and to the temperature output of said sensor.

4. An automotive washer system according to claim 3, further comprising a heater for increasing the temperature of fluid within said mixer, with said heater being operated by said controller such that said heater is energized according to the stored values of temperature and fluid proportion.

5. An automotive washer system according to claim 1, further comprising a temperature sensor operatively connected with said controller and a fluid distribution system operatively associated with said mixer, with said fluid distribution system having a heater operated by the controller according to at least the output of said sensor.

6. A temperature adaptive automotive washer system comprising:
a first reservoir containing a freezable fluid;
a second reservoir containing a freeze-resistant fluid;
a mixer for combining fluids from the first and second reservoirs;
a fluid distribution system operatively associated with said mixer;
a heater for increasing the temperature of at least a portion of said fluid distribution system;
a temperature sensor for measuring a temperature of at least a portion of said washer system; and
a controller, operatively connected with the mixer, the temperature sensor, and the heater, with said controller determining a relative proportion for combining the fluids from said first and second reservoirs and operating the heater, as a function of at least the temperature measured by the temperature sensor.

7. An automotive washer system according to claim 6, wherein said controller comprises a memory for storing a temperature value corresponding to the temperature of at least a portion of the fluid distribution system and the mixer each time fluid passes through the fluid distribution system, with said controller operating the heater as a function of at least a previously stored value of said temperature.

8. An automotive washer system according to claim 6, wherein said controller determines said relative proportion so as to use a minimum amount of fluid from said second reservoir.

9. A method for operating an automotive washer system, comprising the steps of:
measuring a temperature related to the temperature of said system;
reading a previously stored system mix value;
determining whether the said previous mix value is suitable for the measured temperature;
calculating a new value based at least in part upon the measured temperature; and
applying heat to the washer system in the event that the previously stored mix value corresponds to a temperature in excess of the measured system temperature.

10. A method according to claim 9, further comprising the steps of mixing washer fluid from a plurality of reservoirs according to the new mix value and applying the mixed fluid to an outer surface of a vehicle.
